(19) United States
(12) Patent Application Publication
(10) Pub. No.: US 2016/0230238 A1
(43) Pub. Date: Aug. 11, 2016

(54) Leather Lace Beveling Apparatus and Method

(71) Applicant: L. Ronnie Nettles, Madisonville, TX (US)

(72) Inventor: L. Ronnie Nettles, Madisonville, TX (US)

(21) Appl. No.: 14/885,069

(22) Filed: Oct. 16, 2015

Related U.S. Application Data
(60) Provisional application No. 62/064,572, filed on Oct. 16, 2014.

(51) Int. Cl. C14B 11/00; B26D 7/02; B26D 1/01

(52) U.S. Cl. CPC C14B 11/00; B26D 1/015; B26D 7/025

(57) ABSTRACT

A leather lace beveler apparatus and method is provided for cutting bevels on opposed sides of a strip of leather lace that is pulled through the leather lace beveler apparatus. The apparatus has a main frame and a first knife housing secured to the main frame and has a knife blade extending through a slot in the main frame. A first fence to holds a leather strip in line and in engagement against the first knife blade to cut a bevel on one side of a strip of leather lace. A second knife housing is secured to the main frame and has a knife blade extending through a slot in the main frame. A second fence holds a leather strip in line and in engagement with the second knife blade to cut a bevel on the other side of a strip of leather lace. The leather lace is pulled through the leather lace beveler apparatus to cut the opposed bevels on the strip of leather lace with the strip of leather lace engaging the first and second knife blades and the first and second fences.

### CROSS-REFERENCE TO RELATED APPLICATIONS

### Statements Regarding Federally Sponsored Research or Development

Applicant claims the benefit of provisional patent application No. 62/064,572 filed Oct. 16, 2014

### REFERENCE TO A MICROFICHE APPENDIX

NA

### BACKGROUND OF THE INVENTION

1. Field of the Invention

This invention relates to the field leather lace making apparatuses and methods.

2. Description of the Related Art

A purpose of the invention is to bevel the edges of lace leather at an angle. Beveling the edges of lace leather is typically done by saddle shops and leather braiders.

There are numerous advantages between the lace beveler apparatus of the invention and the prior art. The lace beveler apparatus of the invention will bevel different widths of lace without having to make adjustments. Applicant is not aware of any prior art machine that can bevel different widths without any adjustments. The lace beveler apparatus of the invention can bevel both sides of the lace at one time. Some machines can only do one side at a time.

The lace beveler apparatus of the invention will bevel a single length of lace that is comprised of different widths of leather throughout its entire length. Some machines are only designed to bevel the same width of leather.

With the lace beveler apparatus of the invention the width or the thickness of leather is generally not a factor in its performance

Some prior art bevelers require the operator to hold the lace with one hand and pull it thru the machine with the other. With the lace beveler apparatus of the invention, the operator can pull the lace through the apparatus hand over hand to bevel the edges. The ability to pull the lace hand over hand quickens the process, allowing the lace to be beveled as quickly as the operator can pull the leather thru the machine.

The blades used in the lace beveler apparatus of the invention can generally be used longer. The entire blade can be used in the lace beveler apparatus of the invention since the blade can be adjusted.

Most beveling machines require some expertise to use while the lace beveler apparatus of the invention can generally be used by any laborer.

Known prior art includes the following U.S. Pat. Nos. 2,559,291; 2,781,532; 2,978,808; 3,080,652; 3,802,076; 4,218,901; 4,226,098; 5,027,621; 7,225,647; 8,033,146; 8,485,004

### BRIEF SUMMARY OF THE INVENTION

The invention comprises a leather lace beveler apparatus for cutting bevels on opposed sides of a strip of leather lace that is pulled through the leather lace beveler apparatus. It includes a main frame and a first knife housing secured to the main frame and has a knife blade extending through a slot in the main frame and has a first fence to hold a leather strip in line and in engagement against the first knife blade to cut a bevel on one side of a strip of leather lace. A second knife housing is secured to the main frame and has a knife blade extending through a slot in the main frame and has a second fence to hold a leather strip in line and in engagement with the second knife blade to cut a bevel on the other side of a strip of leather lace when a leather lace is pulled through the leather lace beveler apparatus.

The leather lace leveler apparatus includes angle slots for the knife blades. The leather lace leveler apparatus includes knife housings for the knife blades. The knife blades are reversible to provide new cutting edges.

The leather lace leveler apparatus includes knife housings mounted in the slots for the knife blades that are selectively slidably positioned in the knife housings and secured in place. The fences include presser plates that press against the lace to hold the lace in line with the knife blades. The fences include springs that cause the presser plates to press against the lace to hold the lace in line with the knife blades. The fences include springs with compression adjusting shafts that cause the presser plates to press against the lace to hold the lace in line with the knife blades. The leather lace leveler apparatus includes adjusting bolts to provide lateral adjustment to the two fences. The leather lace leveler apparatus includes locks on adjusting bolts to provide lateral adjustment to the two fences.

The leather lace leveler apparatus includes a third fence lace to hold the lace in line with the knife blades. The leather lace leveler apparatus includes a stand shaft for mounting the apparatus on a support.

The method for cutting bevels on opposed sides of a strip of leather lace that is pulled through the leather lace beveler apparatus includes the following steps. A strip of leather lace is engaged with a first knife housing having a knife blade and the leather strip is held in line and in engagement against the first knife blade with a first fence to cut a bevel on one side of a strip of leather lace. The strip of leather lace is engaged with a second knife housing having a knife blade and the leather strip is held in line and in engagement against the second knife blade with a second fence to cut a bevel on the other side of a strip of leather lace. The strip of leather lace is pulled past the knife blades to cut the bevels on opposed sides of the leather lace.

The fences are laterally adjusted to cut the bevels on the opposed sides of the strip of leather lace. The pressure of the fences is adjusted to cut the bevels on the opposed sides of the strip of leather lace. The leather strip is held in line and in engagement against the knife blades with a third fence to cut a bevel on the other side of a strip of leather lace

### BRIEF DESCRIPTION OF THE SEVERAL VIEWS OF THE DRAWINGS

FIG. 1 is a perspective view of the top of the apparatus of the invention.

FIG. 2 is a perspective view of the apparatus of the invention with a piece of leather lace in position for beveling.

FIG. 3 is a perspective view of the apparatus of the invention with a piece of leather lace in position being beveled.

FIG. 4 is a perspective view of the apparatus of the invention with a piece of leather lace in position nearing completion of being beveled.

FIG. 5 shows a representative strip of leather lace that has been beveled by the apparatus of the invention.

FIG. 6 is a perspective view of a knife holder of the apparatus of the invention for beveling a piece of leather lace.

FIG. 7 is a perspective view of a fence holder for the apparatus of the invention for holding a piece of leather lace in position to be beveled.

FIG. 8 is a perspective view of the bottom of apparatus of the invention.

### DETAILED DESCRIPTION OF THE INVENTION

Referring to FIG. 1, the lace beveler apparatus 10 is shown. The apparatus includes a main frame 11 having straight sides 12, 13, 14, and 15 with rounded corners and an upper surface 16. The main frame is rectangular and approximately 4×7 inches in the preferred embodiment. It may be made of 10 gauge stainless steel.

Referring to FIG. 8, a 1×4 inch stainless steel tubular or solid stand-shaft 18 is secured to the lower surface 17 between two angled slots 19 and 20 that are cut into the main frame. The angled slots are at an angle of about 30 degrees from the sides 12 and 14 of the main frame 11. The end 21 of the shaft is welded approximately 2½ inches from one end 15 and approximately 1⅞″ from the side 12 for mounting or clamping the shaft in a standard vise, not shown, or other support. A one inch stainless steel washer 22 is secured to the shaft 2½ inches from the lower surface 17 of the main frame 11.

The two angled slots 19 and 20 are approximately 1 3/6×¼′ wide and are cut into the main frame 11 for mounting the knife housings 23 and 24. The knife housings 23 and 24 are secured in the slots at an angle of about 45 degrees as shown by suitable connections such as by welding.

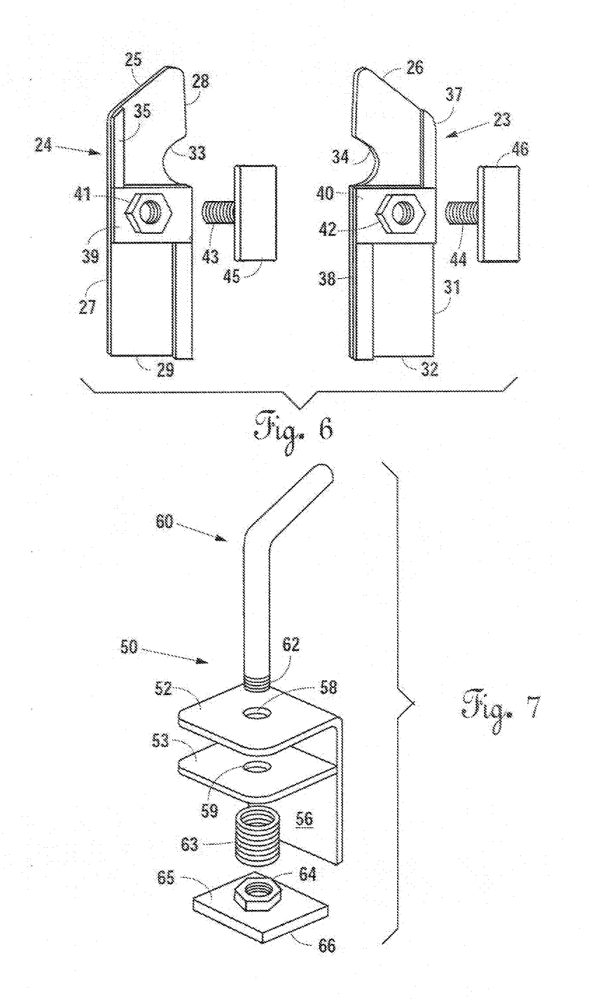

Referring to FIG. 6, the knife housings 23 and 24 are generally rectangular with sides 27, 28, 30 and 31 and ends 29 and 32 except for the upper ends 25 and 26 which are angled. The knife housings 23 and 24 are approximately 1⅛×3⅞ inches in size with half-moon shaped slots 33 and 34 formed in the housings that are approximately ⅝″ in diameter to expose the cutting edge of a replaceable box knife blade. The knife housings have shims 35, 36, 37 and 38 to position a box knife blade that can be selectively slidably positioned in the housing and replaced when the cutting edge dulls. The center of each half-moon slot is approximately 1¼ inch from the upper end and allows the exposed cutting blade surface of the box knife blade to bevel the lace. The top edges 25 and 26 of the housings are angled approximately 45 degrees to coincide with the end of a box knife blade angle. The bottom shims 36 and 38 run from the bottom of the housing up two inches and the top shims 35 and 36 run from the beveled edges 25 an 26 down approximately 1¾ inches.

Referring to FIG. 6, steel plates 39 and 40 are approximately 1×¾ inch and are welded to the shims just below the half-moon circles. Holes are formed in the center of the plate with ¼ inch nuts 41 and 42 welded over the holes. The ¼ inch nuts secure the ¼ inch wing bolts 43 and 44 with wing handles 45 and 46 that can be screwed in to securely hold a box knife blade in each of the knife housings 23 and 24. The wings 45 and 46 may also be round knobs. The standard box knife blade is typically angled at both ends so that either end may be slidably secured in the housing with the wing bolt. The sharp cutting edge of the knife blade can be varied by loosening the wing bolts 43 and 44 and sliding the knife blade in the house to a new cutting edge as the blade edge dulls from use.

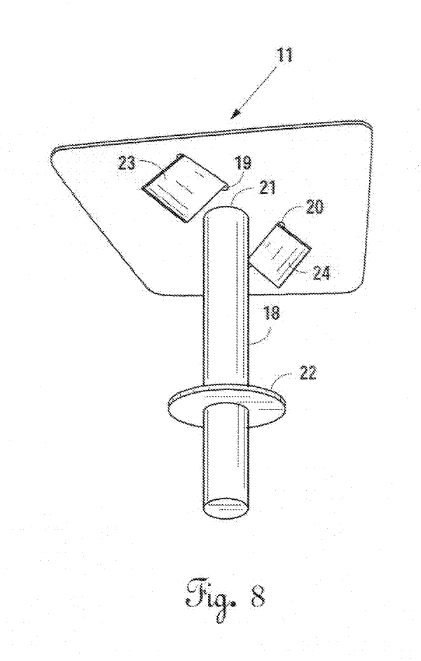

Referring to FIG. 1 and FIG. 7 there are two identical stainless steel fences that are F-shaped and approximately 2 inches long×⅞ inch wide with a ¼ inch hole in the centers of the horizontal legs of the fences. The fences 50 and 51 have two 90 degree brackets 52, 52, 54 and 55 with ¼ inch holes 58 and 59 in the center of each bracket. The brackets 52, 52, 54 and 55 are affixed to the vertical flat members 56 and 57. The brackets 52, 52, 54 and 55 are attached to the fence leg approximately ⅝″ apart.

Referring to FIG. 1, the first and second fences 50 and 51 each have ¼×3 inch threaded shafts 60 and 61 that are bent at 90 degrees and are about 2⅛ inches from the threaded end 62. As shown in FIG. 7, the shaft 60 is mounted thru the openings 58 and 59 in the two 90 degree brackets. A ¼ by 1 inch coil spring 63 slides over each shaft. Each shaft then screws into the nut 64 on the upper surface 65 of the presser foot 66 causing it to be spring-loaded so the lower flat surface 66 of the press plate presses against the top surface of the main frame.

Two stainless steel bolts 70 and 71 that are ¼×2 inches long with plastic adjusting knobs 71 secured on each end are provided to allow lateral adjustment of the two fences. The knobs 71 may be round or rectangular. Each plastic knob allows for adjusting the lateral position of the fences to properly position them relative to the knives.

Two ¼ inch nut connectors 73 and 74 are mounted on posts or stands 75 and 76 which are connected to the top surface of the main frame and receive the bolts 70 and 71. The posts or stands 75 and 76 are secured extending upwardly from the top surface 16 of the main frame 11 by suitable connections such as welding. Each assembly is used to attach the first and second fences to the main frame. Nuts 80 and 81 are secured to the backs of the fences 56 and 57 to receive the threaded ends of the bolts 70 and 71. Locking taps 82, 83, 84 and 85 secure the bolts 70 and 71 from rotation on the posts or stands 75 and 76.

The plastic knobs 72 and 74 rotate the ¼ inch threaded bolts to adjust the distance of the fences from the knives. The apparatus may be inserted into a vise or may be attached to a support for positioning the apparatus for use. Nuts 80 and 81 are secured to the backs of the fences 56 and 57 to receive the threaded ends of the bolts 70 and 71

The third fixed fence 90 is a tubular member that has a 90 degree bend 91 that extends downwardly where it is secured to the main frame. The lower flat surface 92 is parallel to the surface 16.

The lace beveler apparatus has the first and second fences along with a spring-loaded pressure foot on each fence pressing against the flat main frame to hold the leather lace that is being beveled in place. The first fence holds the lace in line with the first blade. The second fence hold the leather lace in line with the second blade. The third fence guides the lace precisely into the knives. The blade closest to the operator is the second blade. The lace being beveled is laid between the first and second fences underneath each pressure foot and in contact with the cutting blades. Beveling will begin at this position so you need enough lace extending past the second fixed fence to grasp and pull. Should you wish to start beveling near the beginning of the lace you can use pliers to pull the lace through at the beginning.

As shown in FIGS. 2-4, you first slide the lace 99 behind the third fence. You then slide the lace 99 under the presser foot of the first fence and in contact with the first cutting blade. You then slide the lace 99 under the second presser foot of the second fence and in contact with the second cutting blade. With the lace engaging the blades and fences you can pull the lace thru the apparatus to bevel the edges of the leather lace on each side. The spring-loaded presser feet are positioned to hold the lace against the top surface of the flat main frame while the three fences guide it into the knives for precision cutting each edge. The fences can be adjusted for fine tuning the cut.

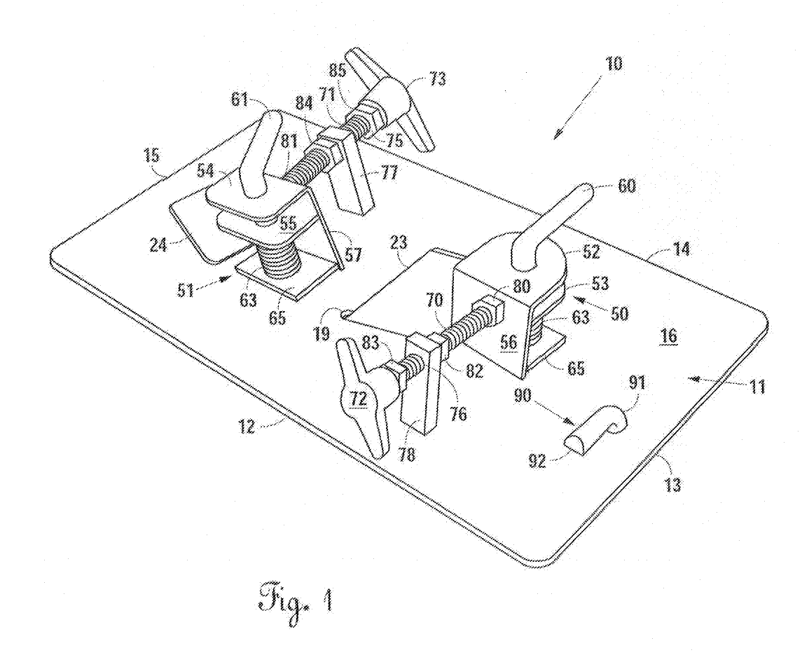

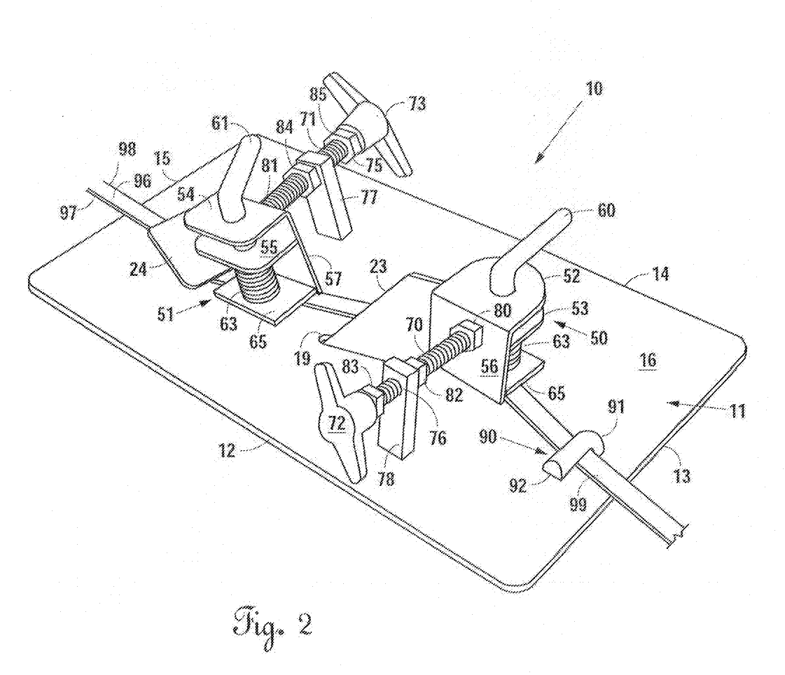

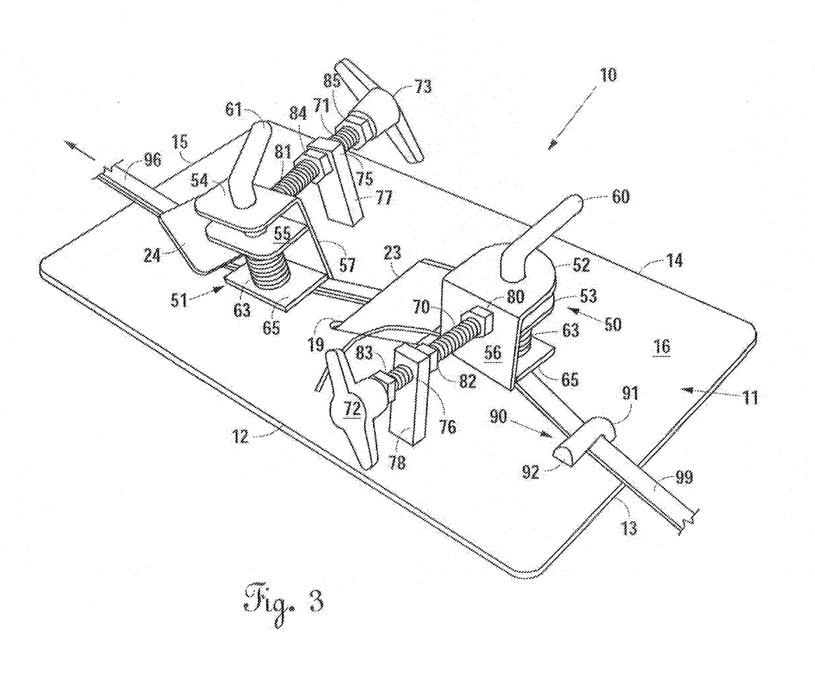

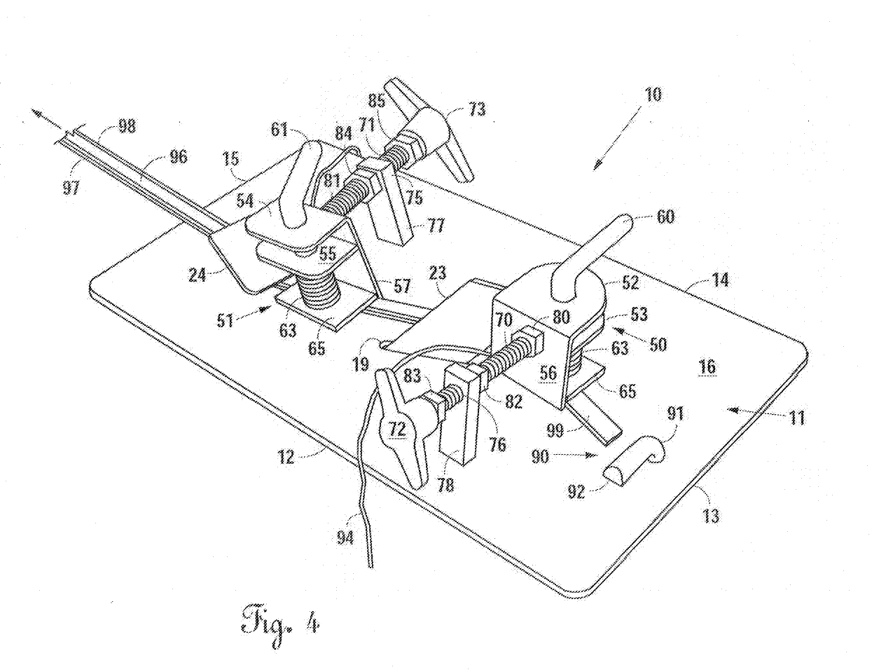

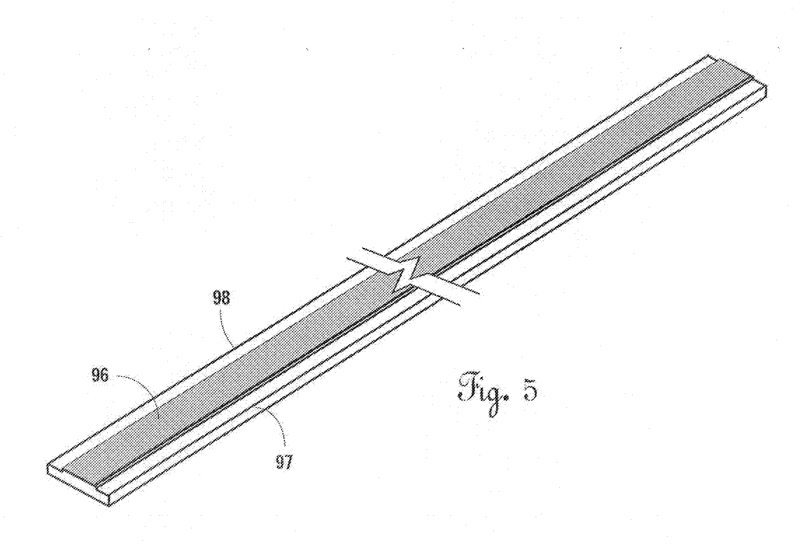

As shown in FIG. 4, the scrap material 94 and 95 from each side of the leather lace is removed at each side of each blade to leave the finished product 96 with finished beveled edges 97 and 98. The finished product is shown in FIG. 5.

The above-listed sections and included information are not exhaustive and are only exemplary or the invention. The particular sections and included information in a particular embodiment may depend upon the particular implementation and the included devices and resources. Although a system and method according to the present invention have been described in connection with the preferred embodiments, it is not intended to be limited to the specific form set forth herein, but, on the contrary, it is intended to cover such alternatives, modifications, and equivalents, as can be reasonably included within the spirit and scope of the invention as defined by the appended claims.

The above-listed sections and included information are not exhaustive and are only exemplary or the invention. The particular sections and included information in a particular embodiment may depend upon the particular implementation and the included devices and resources. Although a system and method according to the present invention have been described in connection with the preferred embodiments, it is not intended to be limited to the specific form set forth herein, but, on the contrary, it is intended to cover such alternatives, modifications, and equivalents, as can be reasonably included within the spirit and scope of the invention as defined by the appended claims.

We claim:

1. A leather lace beveler apparatus for cutting bevels on opposed sides of a strip of leather lace that is pulled through the leather lace beveler apparatus comprising:
a main frame;
a first knife housing secured to the main frame and having a knife blade extending through a slot in the main frame and having a first fence to hold a leather strip in line and in engagement against the first knife blade to cut a bevel on one side of a strip of leather lace; and
a second knife housing secured to the main frame and having a knife blade extending through a slot in the main frame and having a second fence to hold a leather strip in line and in engagement with the second knife blade to cut a bevel on the other side of a strip of leather lace when a leather lace is pulled through the leather lace beveler apparatus.

2. The leather lace beveler apparatus of claim 1, comprising:
The leather lace leveler apparatus includes angle slots for the knife blades.

3. The leather lace beveler apparatus of claim 1, comprising:
The leather lace leveler apparatus includes knife housings for the knife blades.

4. The leather lace beveler apparatus of claim 1, comprising:
the knife blades are reversible to provide new cutting edges.

5. The leather lace beveler apparatus of claim 1, comprising:
The leather lace leveler apparatus includes knife housings mounted in the slots for the knife blades that are selectively slidably positioned in the knife housings and secured in place.

6. The leather lace beveler apparatus of claim 1, comprising:
The fences include presser plates that press against the lace to hold the lace in line with the knife blades.

7. The leather lace beveler apparatus of claim 1, comprising:
The fences include springs that cause the presser plates to press against the lace to hold the lace in line with the knife blades.

8. The leather lace beveler apparatus of claim 1, comprising:
The fences include springs with compression adjusting shafts that cause the presser plates to press against the lace to hold the lace in line with the knife blades.

9. The leather lace beveler apparatus of claim 1, comprising:
The leather lace leveler apparatus includes adjusting bolts to provide lateral adjustment to the two fences.

10. The leather lace beveler apparatus of claim 1, comprising:
The leather lace leveler apparatus includes locks on adjusting bolts to provide lateral adjustment to the two fences.

11. The leather lace beveler apparatus of claim 1, comprising:
The leather lace leveler apparatus includes a third fence lace to hold the lace in line with the knife blades.

12. The leather lace beveler apparatus of claim 1, comprising:
The leather lace leveler apparatus includes a stand shaft for mounting the apparatus on a support.

13. A leather lace beveler apparatus for cutting bevels on opposed sides of a strip of leather lace that is pulled through the leather lace beveler apparatus comprising:
a main frame;
a first angled slot in the main frame;
a first knife housing secured to the main frame;
the knife housing including a knife blade;
a first fence on the main frame to hold a leather strip in line against the first knife blade to cut a bevel on one side of a strip of leather lace;
a second angled slot in the main frame;
a second knife housing secured to the main frame;
the second knife housing including a knife blade;
the knife housings being mounted in the slots for the knife blades that are selectively slidably positioned in the knife housings and secured in place;
a second fence on the main frame to hold a leather strip in line against the second knife blade to cut a bevel on the of other side of the strip of leather lace when a leather lace is pulled through the leather lace beveler apparatus;
the fences including springs with compression adjusting shafts that cause the presser plates to press against the lace to hold the lace in line with the knife blades;
adjusting bolts to provide lateral adjustment to the two fences; and
a third fence lace to hold the lace in line with the knife blades.

14. A method for cutting bevels on opposed sides of a strip of leather lace that is pulled through the leather lace beveler apparatus comprising the steps of:
engaging a strip of leather lace with a first knife housing having a knife blade and holding the leather strip in line and in engagement against the first knife blade with a first fence to cut a bevel on one side of a strip of leather lace;
engaging the strip of leather lace with a second knife housing having a knife blade and holding the leather strip in line and in engagement against a second knife blade with a second fence to cut a bevel on the other side of a strip of leather lace;
pulling the strip of leather lace past the knife blades to cut the bevels on opposed sides of the leather lace.

15. The method for cutting bevels on opposed sides of a strip of leather lace that is pulled through the leather lace beveler apparatus comprising the steps of:
laterally adjusting the fences to cut the bevels on the opposed sides of the strip of leather lace.

16. The method for cutting bevels on opposed sides of a strip of leather lace that is pulled through the leather lace beveler apparatus comprising the steps of:
adjusting the pressure of the fences to cut the bevels on the opposed sides of the strip of leather lace.

17. The method for cutting bevels on opposed sides of a strip of leather lace that is pulled through the leather lace beveler apparatus comprising the steps of:
holding the leather strip in line and in engagement against a the knife blades with a third fence to cut a bevel on the other side of a strip of leather lace
